(19) United States
(12) Patent Application Publication
(10) Pub. No.: US 2019/0078376 A1
(43) Pub. Date: Mar. 14, 2019

(54) PREFABRICATED WINDOW SILL

(71) Applicants: Daniel Callaghan, Cheltenham Gloucestershire (GB); Richard Benson, Cheltenham Gloucestershire (GB); Andrew Corkery, Passage West (IE); Paul O'Neill, Tramore (IE)

(72) Inventors: Daniel Callaghan, Cheltenham Gloucestershire (GB); Richard Benson, Cheltenham Gloucestershire (GB); Andrew Corkery, Passage West (IE); Paul O'Neill, Tramore (IE)

(21) Appl. No.: 16/188,711

(22) Filed: Nov. 13, 2018

Related U.S. Application Data
(63) Continuation-in-part of application No. 15/116,314, filed on Aug. 3, 2016.

(30) Foreign Application Priority Data
Feb. 3, 2014 (GB) 1401770.1

(51) Int. Cl. E06B 1/70

(52) U.S. Cl. CPC E06B 1/702

(57) ABSTRACT

A prefabricated window sill 10 suitable for external use comprises a closed cast outer shell 12 having at least an upper surface 16, a lower surface 18, a front surface 20, a rear surface 22 and first and second end surfaces 24, 26. The shell is made from a composite of a plastic polyester resin mixed with either crushed marble or crushed glass, with a catalyst which causes the resin to set; the shell being filled with an expanded plastics foam.

The invention relates to a prefabricated window sill having a high thermal insulation value and a number of other unique properties.

### BACKGROUND TO THE INVENTION

Solid wall buildings with no insulation are estimated to lose around 38% of their heat through the walls in winter. In the UK and other European states, governments are introducing targets to reduce the thermal loss from property, in order to try and reduce energy consumption and greenhouse gases created in energy generation.

It is now common practice to apply insulation materials, such as Expanded Polystyrene (EPS) provided in panels, to the exterior of a building in order to reduce thermal loss from the building. It is common to fix the panels to the building, sometimes with reinforcing, and then to apply render or brick/stone effect slip panels over the insulation to weatherproof it. Typically, render is applied in layers, with the base layer being reinforced with a plastics mesh.

The problems in applying these systems arise at openings, such as windows and doors, where cold bridges can occur between the inner walls of the building and exterior, i.e. where there is no insulation, at sills for example. The current practice with sills, where there is an external insulation system, is to apply an oversill to an existing stone or concrete sill, to try and improve the thermal value of the sill. Such oversills are well-known and an example is disclosed, for example, in GB 2500924 A1.

Oversills typically have very little strength, either in bending or compression. They are often manufactured using expanded polystyrene (EPS) and coated on one or two sides with a resin. Examples currently on the market have styrene in the resin, which is acidic and tends to attack the EPS, leading to long term degradation of the EPS and a reduction in the thermal insulation provided by the oversill.

Sometimes oversills are manufactured with EPS insulation covered with a metal skin. This overcomes any problems of acid degradation of the insulation material, but reduces the insulation value of the oversill, because the metal skin is an effective heat conductor and goes some way to mitigating the thermal benefit of the oversill, i.e. the metal is a thermal bridge. The metal skins are typically painted steel or aluminium extrusions, which are sharp to handle during installation. A complete sill may be manufactured from an open metal extrusion filled with foam insulation, as disclosed in US 2008282626 A1, but again the metal forms a thermal bridge. Also, metal is not an attractive material for most domestic buildings and tends to be used more in commercial and industrial applications.

On new build projects, sills also cause handling problems. In the UK, for example, a site worker is only allowed to lift up to 58 kg without assistance. Cast stone, stone or concrete sills are often purchased to fit a particular aperture and may be long. This being the case, they often weigh well in excess of the 58 kg limit and require two people or more to carry them to the position where they need to be built in. They also have little or no thermal insulation qualities and form cold bridges when installed, which must be covered with oversills to match the insulation values of external insulation systems. A 25 mm strip of EPS may be bedded onto the bottom and inner faces of stone sills to provide some insulation, but it is generally inadequate for purpose.

Another problem of stone, cast stone and concrete sills is that they can easily be damaged in storage or transit, on or off site, and repairs are often inadequate and unsightly. Stone is porous and is prone to water damage, particularly in frost conditions, over time. There is also a significant turnaround time from order to delivery, which can delay a build, with consequent penalty costs.

It is an object of the invention to provide an improved window sill which substantially mitigates the aforementioned problems, and which is for general use in the construction of new build property and the renovation of existing property.

### SUMMARY OF THE INVENTION

According to the present invention, there is provided a prefabricated window sill suitable for external use comprising a closed cast outer shell having at least an upper surface, a lower surface, a front surface, a rear surface and first and second end surfaces, the shell being made from a composite of a plastic polyester resin mixed with either crushed marble or crushed glass and a catalyst, causing the resin to set; the shell being filled with an expanded plastics foam.

The window sill of the invention is highly advantageous because it can take the appearance of stone due to the addition of crushed stone or marble with the resin, but it has an extremely high PSI-value, since the whole body of the window sill is filled with an insulation material.

The integral outer shell is formed in a steel or aluminium mould, as explained below, and has a very high strength to weight ratio, both in compression and bending.

Using a composite polyester resin is advantageous as it can include a component with desirable structural properties alongside another component with fire retardant properties, for example. This may be possible but more difficult to achieve using a single polyester resin.

The polyester resin is preferably an isophthalic neopentyl glycol unsaturated polyester resin, marketed under CRYSTIC® 935PA.

Unlike other resin composites, the resin described can withstand thermal shock, for example in ambient weather extremes, and it is also impervious to water.

The catalyst may be a ketone peroxide. Preferably, the catalyst is methyl ethyl ketone peroxide.

Advantageously, a ketone peroxide, in particular methyl ethyl ketone peroxide, can have several peroxide bonds from which to initiate resin-setting processes, meaning that a reduced amount of catalyst is needed to achieve an equivalent resin setting time compared with catalysts having a single peroxide bond. The by-products of the reaction using methyl ethyl ketone peroxide evaporate quickly, aiding the setting process.

The polyester resin may contain a fire retardant component, such as alumina trihydrate, for example. This confers fire-resistant properties to the polyester resin, suppressing smoke production and impeding burning which, in the event of a fire, are advantageous features for materials used to construct buildings.

The outer shell may be between 1 millimetre and 20 millimetres in thickness. A preferred thickness of the outer shell is substantially 12 millimetres. A more preferred thickness of the outer shell is substantially 6 millimetres.

It has been found that a shell of 6 mm thickness, or greater, will resist a hammer blow with little or no marking and so is less vulnerable to damage on site and in transit.

At least one aperture may be provided in the shell for injecting the expanded plastics foam. Ideally two apertures are provided and more apertures may be provided if the sill is very long, for example several metres. The foam is injected in metered shots or batches to minimise waste and to guarantee a perfect fill of the shell each time.

The aperture(s) may be positioned on a lower or rear surface, but should be in a position not exposed to weather, or to detract from the appearance of the window sill.

The expanded plastics foam may be expanded polyurethane and may be composed of a liquid polyisocyanate (such as a diisocyanato diphenyl methane—for example: Cellanate M) and a polyol which is mixed in a nozzle on injection, generally known as a ‘Bio Foam’. Advantageously, the expanded polyurethane has no VOCs, CFCs, HFCs or urea, making it environmentally friendly. The density of the foam can be controlled to produce a required insulation value, as required.

Alternatively, the expanded plastics foam may be of the type commercially known as Icynene®.

The composite forming the shell is preferably formed from a combination of an isophthalic neopentyl glycol unsaturated polyester resin and crushed marble and/or silica sand.

Reinforcing may be disposed inside the shell, which may be of steel, carbon fibre or engineered plastics. Reinforcing may be advantageous where the window sill is under significant load.

The prefabricated window sill may be formed with an elongate recess provided along the lower surface of the shell for serving as a drip bead. A portion of the upper surface may be sloped downwardly towards one side of the sill in conventional manner to take water away from a building, when in situ.

### BRIEF DESCRIPTION OF THE DRAWINGS

For a better understanding of the present invention, and to show more clearly how it may be carried into effect, reference will now be made by way of example only to the accompanying drawings, in which:

FIG. 1 shows a perspective view of a first embodiment of a prefabricated window sill;

FIG. 1A shows a cross-section through the sill of FIG. 1;

FIG. 2 shows a perspective view of an alternative embodiment of a prefabricated window sill; and

FIG. 2A shows a cross-section through the sill of FIG. 2.

### DESCRIPTION OF PREFERRED EMBODIMENTS

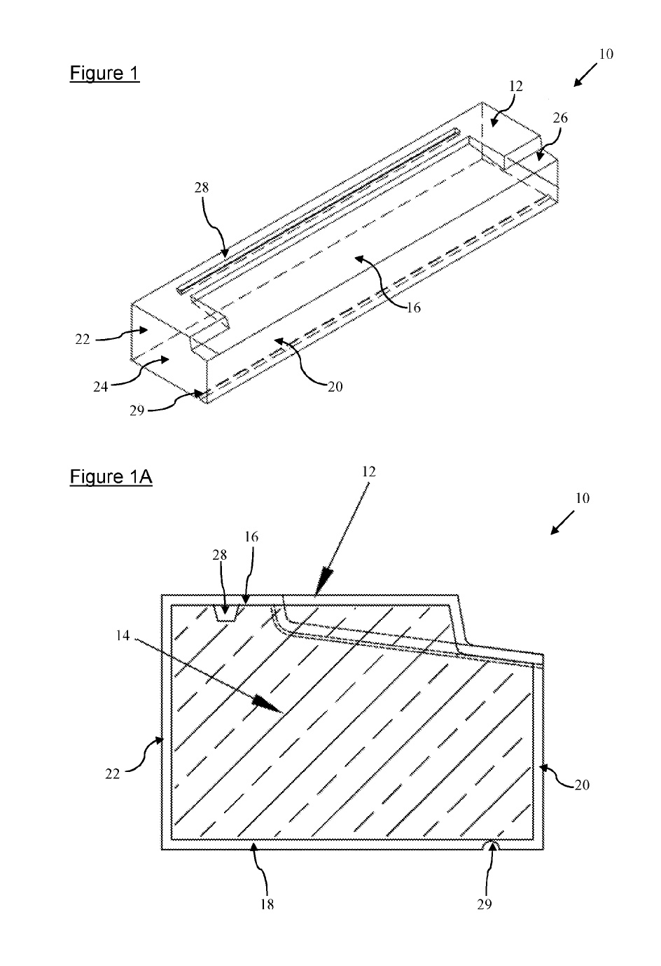

Referring firstly to FIGS. 1 and 1A, a first embodiment of a prefabricated window sill is indicated generally at 10. The sill 10 has a closed cast outer shell 12 and an expanded foam inner 14. In the embodiment shown, the sill 10 is a stooled sill, which is a well-known design shape of sill. The outer shell 12 has an upper surface 16, a lower surface 18, a front surface 20, a rear surface 22 and first and second end surfaces 24, 26. A front area of the upper surface 16 is effectively cut away and slopes downwardly to allow water to run off in conventional manner. Non-sloping areas of the upper surface 16, i.e. substantially parallel with the lower surface 18, are provided at each end of the sill. These areas are preferably rectangular and can be built off, being capable of bearing significant load. A longitudinally extending groove or recess 28 is provided in the upper surface 16 of the sill to provide a key for mortar. Additionally, a second longitudinally extending groove or recess 29 is provided on the lower surface 18 of the shell 12, providing a drip bead. Grooves of this nature are conventional in the field.

The outer shell 12 is made from polyester resin in a steel or aluminium mould. Alternatively, the mould itself can be made from liquid silicone with silicone thickener in a catalysed process. Glass fibre and burlap is used to strengthen the mould as the layers of silicone are laid down, which add both elasticity and strength. The layers of silicone are brushed on evenly by hand and allowed to dry between coats.

The outer shell 12 is cast as a closed casting in a rotational casting machine. Resin, preferably a polyester resin and more preferably an isophthalic neopentyl glycol unsaturated polyester resin, sold under the trade name CRYSTIC® 935PAHR is mixed with a catalyst of methyl ethyl ketone peroxide, and a quantity of crushed marble or glass. The crushed marble or glass may take the consistency of a powder. The resin of the outer shell 12 is allowed to cure, initially at room temperature for around 24 hours, and is then heated to 60 degrees Celsius for around four hours. The heating accelerates the curing process, which at 15 degrees Celsius would take twenty-eight days for an equivalent cure hardness. On removal from the steel or aluminium mould, the outer shell 12 has the appearance of a solid casting, but in fact is hollow.

Alternatively, a composite plastics resin, or more preferably a mixture of at least one orthophthalic unsaturated polyester resin, is used instead of the polyester resin described above. The curing and post-curing processes may differ somewhat from the above temperatures and timescales, depending on the resin used. The catalyst may be another ketone peroxide, or another class of catalyst, where the catalyst used initiates a radical chain reaction (to induce resin setting) and releases a by-product which readily evaporates or dissipates (e.g. acetone, butanone, ether). This allows the resin to dry without retaining solvents which could damage or dissolve other sill components.

The ideal wall thickness of the outer shell 12 has been found to be around 6 mm. However, wall thicknesses between 1 mm and 20 mm are contemplated for different applications and subject to controlled testing. A thicker outer shell of 12 mm thickness is also a suitable compromise for increased sill strength at the expense of increased sill weight, relative to a shell of 6 mm thickness.

Two small holes (not shown) are provided in the top of the outer shell 12, towards respective ends, on the upper surface 16 towards the rear surface 22. The expanded foam insulation 14 is injected through these holes simultaneously to fill the outer shell 12. The expanded plastics foam is expanded polyurethane and is composed of a liquid polyisocyanate and a polyol which is mixed in the injection nozzle(s) on injection. It falls within the class of substances, generally known as a ‘Bio Foams’. Advantageously, the expanded polyurethane does not incorporate VOCs (volatile organic compounds), CFCs (chlorofluorocarbons), HFCs (hydrofluorocarbons) or urea.

The density of the foam can be controlled to produce a required insulation value, as required. The foam has an r-value of 0.025. If the density of the foam is increased, the strength of the window sill in both compression and bending can be improved. The foam has no food value for rodents or insects and is self-bonding. It is also envisaged that expanded plastics foam of the type commercially known as Icynene® is suitable in the same way as expanded polyurethane. A key factor in the choice of the resin and foam is that they must not react together and degenerate in any way. For example, the resin must not break down bonds in the foam causing it to effectively dissolve.

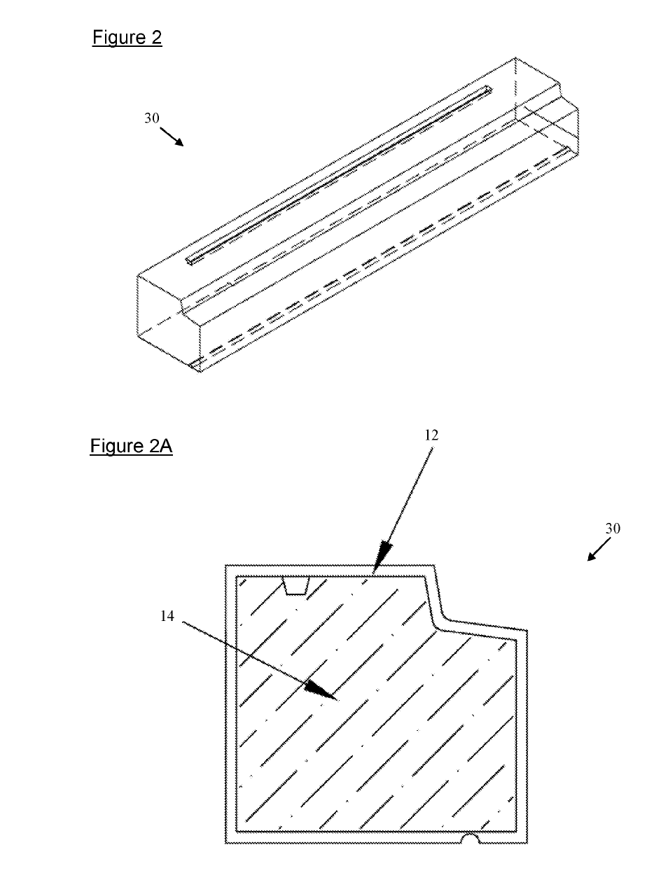

Referring now to FIGS. 2 and 2A, the window sill may also be provided as a standard non-stooled sill, indicated generally at 30. It will be appreciated that in view of the manufacturing process of the window sill, decorative features can be added as desired, as long as they can be moulded effectively. The shell can be moulded around reinforcing material, which may be steel, carbon fibre or engineered plastics, and the foam then injected around the reinforcing. High density polyurethane foam can also be reinforced with strands of fibreglass to make structurally reinforced foam.

It will be appreciated that the window sills described are extremely strong, light to handle, do not have sharp edges, can withstand all weather conditions, have the appearance of stone and, most importantly, can be used with or without external insulation systems to meet required insulation standards. By the use of plastics, cold bridges are entirely avoided. Temperatures inside the structure are therefore less dependent on exterior conditions, remaining warmer in winter and cooler in summer than they might otherwise be, potentially contributing to a reduction of heating costs.

In particular, the composite comprises the combination of about 5 to 35% by weight of isophthalic neopentyl glycol unsaturated polyester resin and about 65 to 95% by weight of crushed marble and/or silica sand, preferably about 15 to 25% by weight of the isophthalic neopentyl glycol unsaturated polyester resin and about 75 to 85% by weight of the crushed marble and/or silica sand, and most preferably about 19% by weight of the isophthalic neopentyl glycol unsaturated polyester resin and about 81% by weight of the crushed marble and/or silica sand.

The expanded plastics foam is preferably a blend of a diisocyanato diphenyl methane foam and a low density polyurethane foam, the diisocyanato diphenyl methane foam comprising a mixture of diphenylmethane-2,4′-diisocyanate, diphenylmethane-4,4′-diisocyanate and diphenylmethanediisocyanate isomers and homologues, and the low density polyurethane foam being a dipropylene glycol methyl ether. In this regard, the expandable foam comprises about 45 to 55% by weight of the diisocyanato diphenyl methane foam and about 45 to 55% by weight of the low density polyurethane foam, preferably about 50:50 by weight of the diisocyanato diphenyl methane foam and the low density polyurethane foam.

In particular, the expandable foam is a blend of Envirofoam 16.464 and Cellanate M.

The embodiments described above are provided by way of example only, and various changes and modifications will be apparent to persons skilled in the art without departing from the scope of the present invention as defined by the appended claims.

1. A prefabricated window sill suitable for external use comprising a closed cast outer shell having at least an upper surface, a lower surface, a front surface, a rear surface and first and second end surfaces, the shell being made from a composite of a polyester resin mixed with either crushed marble or crushed glass, and a catalyst, the shell being filled with an expanded plastics foam, and
the composite forming the shell comprising the specific combination of an isophthalic neopentyl glycol unsaturated polyester resin and crushed marble and/or silica sand.

2. The prefabricated window sill of claim 1, wherein the composite comprises the combination of about 5 to 35% by weight of the isophthalic neopentyl glycol unsaturated polyester resin and about 65 to 95% by weight of the crushed marble and/or silica sand.

3. The prefabricated window sill of claim 2, wherein the composite comprises about 15 to 25% by weight of the isophthalic neopentyl glycol unsaturated polyester resin and about 75 to 85% by weight of the crushed marble and/or silica sand.

4. The prefabricated window sill of claim 3, wherein the composite comprises about 19% by weight of the isophthalic neopentyl glycol unsaturated polyester resin and about 81% by weight of the crushed marble and/or silica sand.

5. The prefabricated window sill of claim 1, wherein the expanded plastics foam is a blend of a diisocyanato diphenyl methane foam and a low density polyurethane foam.

6. The prefabricated window sill of claim 5, wherein the diisocyanato diphenyl methane foam comprises a mixture of diphenylmethane-2,4′-diisocyanate, diphenylmethane-4,4′-diisocyanate and diphenylmethanediisocyanate isomers and homologues, and the low density polyurethane foam is a dipropylene glycol methyl ether.

7. The prefabricated window sill of claim 5, comprising about 45 to 55% by weight of the diisocyanato diphenyl methane foam and about 45 to 55% by weight of the low density polyurethane foam.

8. The prefabricated window sill of claim 7, comprising about 50:50 by weight of the diisocyanato diphenyl methane foam and the low density polyurethane foam.
